(19) United States
(12) Patent Application Publication
(10) Pub. No.: US 2008/0085405 A1
(43) Pub. Date: Apr. 10, 2008

(54) ADHESIVE TAPE HAVING A CARRIER WHICH IS COMPOSED OF ONE OR MORE CARRIER FILMS, THE CARRIER BEARING ON AT LEAST ONE SIDE AN ADHESIVE APPLIED AT LEAST PARTIALLY

(75) Inventors: Alexander Prenzel, Hamburg (DE); Bernd Luhmann, Norderstedt (DE); Bernhard Mussig, Seevetal (DE)

Correspondence Address: NORRIS, MCLAUGHLIN & MARCUS, P.A., 875 THIRD AVE, 18TH FLOOR, NEW YORK, NY, 10022, US

(73) Assignee: tesa Aktiengesellschaft, Hamburg (DE)

(21) Appl. No.: 11/562,270

(22) Filed: Nov. 21, 2006

(30) Foreign Application Priority Data
Oct. 6, 2006 (DE) 10 2006 047 734.0

(51) Int. Cl. B32B 7/12; B29C 67/00; B32B 27/32

(52) U.S. Cl. 428/220; 264/175; 428/343; 977/752

(57) ABSTRACT

Adhesive tape having a carrier which is composed of one or more carrier films, at least one side of the carrier bearing an adhesive applied at least partially, characterized in that at least one of the carrier films comprises at least one homopolymer, copolymer or terpolymer of propylene and in that there are carbon nanotubes (CNTs) in at least one of the carrier films.

The invention relates to adhesive tape having a carrier which is composed of one or more carrier films, the carrier bearing on at least one side an adhesive applied at least partially.

Films possessing high longitudinal strength are typically achieved by orienting melt-extruded, partially crystalline thermoplastics such as polypropylene or polyester. The orientation in question is predominantly biaxial. There are films which, for the purpose of further increasing the longitudinal strength, are oriented only in machine direction (i.e. longitudinal direction) and which as a result have particularly high tensile strengths and elasticity moduli. These films are used for producing what are called strapping tapes, which serve in bundling applications and closure securement applications, and tear-open strips.

EP 0 255 866 A1 describes an adhesive tape made from a polypropylene carrier which comprises LLDPE as plasticizer. LLDPE enhances the toughness of the film, but lowers the tensile strength and elasticity modulus.

DE 36 40 861 A1 describes a tear-open strip whose tendency to tear off is reduced through use of a film which is oriented in machine direction and produced by coextruding raw materials differing in toughness. The tough and flexible coextrusion layer reduces the formation of microcracks when the product is cut, and thereby improves the lateral-tear strength. However, it does not only contribute to the tensile strength and elasticity modulus; the increase in thickness also limits the maximum running length of the adhesive tape in automatic applicators.

In cases of high load it is necessary for films, and/or adhesive tapes produced using them, to be reinforced with filaments or nets of glass or plastic. The production of such filament adhesive tapes is very involved from the equipment standpoint and is therefore expensive and susceptible to faults.

Besides the base film, there is an additional requirement for the filaments and laminating adhesives (or additional pressure-sensitive adhesive coatings), which makes the products more expensive still and ties up a greater quantity of raw material resources. Further disadvantages of such filament adhesive tapes are the low crease fracture resistance, the unclean cut edges, and the absence of weldability and recyclability. Their production is described in U.S. Pat. No. 4,454,192 A, for example.

U.S. Pat. No. 4,592,938 A discloses a process for producing films for plastic bags, handles and stretch packaging. A reinforcing effect is obtained in the interior of the film by virtue of coextruded filament-like strips extending in the machine direction. The process cannot be applied to polypropylene, since the typical gel fraction automatically clogs the filament channels of the die. The films are unoriented and therefore of only low longitudinal strength.

U.S. Pat. No. 5,145,544 A and U.S. Pat. No. 5,173,141 A describe an adhesive tape made from monoaxially oriented film having a rib structure for reinforcement, with some of the ribs projecting from the surface and some being embedded in the surface of the film, with notch-like joints being formed between film and ribs. The film attains high lateral-tear strength, but the tensile strength and extensibility are still needy of improvement. The essential defect is that the film cannot be produced on the production scale. The rib structure at the surface also leads readily to coating defects when release agents or primers are applied in the course of further processing to adhesive tapes, since the application methods for films require a smooth surface. Moreover, films with reinforcing strips or rib structures in or on the surface are deleterious for printing, which presupposes flat surfaces. Particularly when the film disclosed is used for an adhesive packaging tape, printability is a criterion important to the customer. EP 1 101 808 A1 attempts to remove the aforementioned drawbacks by moving the rib structures into the interior of the film. The invention, however, is not implemented industrially, since the production process is very involved. All of the stated films, as compared with a normal adhesive-tape film, feature an improved tensile strength and a better elasticity modulus in machine direction, but can be produced only with relative complexity and expense. On the other hand, they fail by far to attain the properties of products featuring glass filaments or polyester filaments.

Compounds of polypropylene and glass fibres are known for injection-moulding applications but cannot be processed to films, on account of the size of the fibres, and hence cannot be employed as glass-fibre-reinforced film carriers for adhesive tape.

Nanotubes are tubes whose diameter is less than 100 nanometres and typically just a few nanometres (the inner tubes in multiwalled nanotubes can be down to 0.3 nanometre in thinness). For the tube to be considered such, the length ought to exceed the diameter; in the case of carbon nanotubes, lengths of 20 cm are attained. Lengths of a few micrometers are typical.

Nanotubes may be of single-wall or multi-wall types (single-wall nanotubes, SWNT, or multiple-wall nanotubes, MWNT), and the wall may form a closed ring or a spiral structure. Depending on production conditions, whole bundles or filaments of nanotubes are also obtained.

Carbon nanotubes (CNT) are microscopically small, tubular structures (molecular nanotubes) of carbon.

Their walls, like those of the fullerenes or like the planes of graphite, consist only of carbon, the carbon atoms taking up a honeycomb structure with hexagons and in each case three bonding partners (predetermined by the sp² hybridization). The diameter of the tubes is in the range from 1 to 50 nm. Lengths of several millimetres for individual tubes and up to 20 centimetres for tube bundles are attained.

Distinctions are made between single-wall and multi-wall tubes, between open or closed tubes (with a cover which has a section taken from a fullerene structure), and between empty and filled tubes.

Depending on the detail of the structure, the electrical conductivity within the tubes is metallic or semiconducting. There are also carbon tubes known which at low temperatures are superconducting.

The mechanical properties of carbon nanotubes are outstanding. CNTs have a density of 1.3 to 1.4 g/cm³ and a tensile strength of 45 billion pascals.

One particular form of carbon nanotubes are aggregated diamond nanotubes (ADNRs, Aggregated Diamond NanoRods). ADNRs are the densest known form of carbon. ADNRs are produced from fullerene at high temperature (2500 kelvins) and high pressure (20 GPa). They possess a compression modulus of 491 GPa, whereas diamond attains only 442 GPa.

The interest in carbon nanotubes as fillers and especially in single-walled carbon nanotubes (SWNTs) is growing continually on account of their unique chemical and physical properties and also their possibilities for use in the material sciences [Baughman R H, Zakhidov A A, de Heer W A: “Carbon nanotubes—a route toward applications,” Science 2002, 297, 787 to 792]. In spite of the numerous activities in this field, however, it has not been possible to provide complete answers to many questions concerning the effective dispersing of the nanotubes in a polymer matrix. SWNTs possess an extraordinary combination of mechanical, electrical and thermal properties. They have tensile stresses of 50 to 200 GPa and calculated Young's moduli of TPa [Yu M-F, Lourie O, Dyer M J, Moloni K, Kelly T F, Ruoff R S: “Strength and Breaking Mechanism of Multiwalled Carbon Nanotubes Under Tensile Load,” Science 2000, 287, 637 to 640]. When imposed to a bending load and then released, SWNTs return to their original shape without rupturing, and constitute outstanding starting materials for the development of nanoreinforced polymer composite materials, based on the extraordinary mechanical properties and on the high aspect ratio (typically ˜103) of the individual SWNTs [Mitchell C A, Bahr J L, Arepalli S, Tour J M, Krishnamoorti R: “Dispersion of Functionalized Carbon Nanotubes in Polystyrene,” Macromolecules 2002, 35, 8825 to 8830]. SWNT-based composite materials can be considered, moreover, on account of their good optical, electrical and electronic properties, as suitable “active” components in innovative materials and applications [Wu Z, Chen Z, Du X, Logan J M, Sippel J, Nikololu M, Kamaras K. Reynolds J R, Tanner D B, Hebard A F, Rinzler A G: “Transparent, Conductive Carbon Nanotube Films,” Science 2003, 305, 1273 to 1276].

In the intervening period the focal points of research have been trained, on account of their better dispersibility, on multiwalled carbon nanotubes (MWNTs) and on their use in polymer composites [Wu H-L, Ma C-C M, Yang Y-T, Kuan H-C, Yang C-C, Chiang C-L: “Morphology, Electrical Resistance, Electromagnetic Interference Shielding and Mechanical Properties of Functionalized MWNT and Poly(urea urethane) Nanocomposites,” J. Pol. Sci., Part B: Polymer Physics 2006, 44, 1096 to 1105]. Polymer-MWNT composites have mechanical properties far superior to those of conventional polymer-based composites, on account of the intrinsic strength and modulus. The fact that the efficiency of stress transfer in certain systems is better by more than one order of magnitude further illustrates the advantage of the MWNTs as filling materials. The reinforcing effect of MWNTs has been demonstrated by both mechanical and dynamomechanical analysis methods (DMA). For a filler content of 1% it has been possible to increase the moduli by in certain cases up to 40%, an effect associated with only a small increase in T_{g}. Even with increased filler fractions, the crystallinity—in the case of PP, for example—has gone up only slightly. From these results it is clearly possible to conclude that nanotube-polymer composites of this kind are suitable for modifying and positively influencing a range of material-related properties.

Although polymer-SWNT composites display a much more promising potential for use as high-performance materials in comparison to the MWNT-based composites, there are nevertheless generally problems associated with dispersion, and so far the use of SWNTs is not profitable from an economic standpoint.

The MWNTs may be constructed of two to 15 graphite-like layers, and when there are two layers are frequently referred to also as double-walled carbon nanotubes (DWNTs). The walls both of the SWNTs and of the MWNTs may have a “normal” structure, an armchair structure, a zigzag structure or a chiral structure, which differ in the degree of twist. The diameter of the CNTs can be between 1 and 100 nm, it being possible for the tubes to adopt a length of up to one millimetre [Szleifer I, Yerushalmi-Rozen R: “Polymers and carbon nanotubes—dimensionally, interactions and nanotechnology,” Polymer 2005, 46, 7803 to 7818].

EP 1 437 379 A1 describes films of polypropylene with added phyllosilicates (nanoclays), which as a result of biaxial orientation have reduced oxygen permeability and water-vapour permeability. The effect derives from the orientation of the platelet-shaped fillers. An increase in tensile strength as a result of the phyllosilicates is not observed, although a slight increase in flexural rigidity is, as is usual with the addition of fillers.

WO 2005/017012 A1 describes the development of pressure-sensitive adhesive tapes which are constructed from, among other components, an adhesive into which CNTs have been homogeneously dispersed. No improvement in adhesion or cohesion, or general mechanical reinforcement, is disclosed, however. WO 2006/048847 A1 likewise describes a CNT-containing adhesive in which by virtue of the specific orientation of the CNTs a directionally dependent conductivity has been obtained; again, however, there is no apparent reinforcement of the mechanical properties.

It is an object of the invention to produce an adhesive tape which in the longitudinal or machine direction has high modulus values (in the form for example of the stress at 10% extension) and tensile strengths and which is producible by means of an extremely simple process.

This object is achieved by means of an adhesive tape as specified in the main claim. The dependent claims provide advantageous developments of the subject matter of the invention. The invention further provides processes for producing the adhesive tape of the invention.

The invention accordingly provides an adhesive tape having a backing which is composed of one or more carrier films, the carrier bearing on at least one side an adhesive tape applied at least partially.

At least one of the carrier films comprises at least one homopolymer, copolymer or terpolymer of propylene, and there are carbon nanotubes (CNTs) in at least one of the carrier films.

The general expression “adhesive tape” embraces for the purposes of this invention all sheetlike structures, such as films or film sections of two-dimensional extent, tapes with extended length and limited width, tape sections, diecuts, labels and the like.

The carrier films are preferably composed of polypropylene alone.

The carrier is preferably composed of a single carrier film.

In a further advantageous embodiment of the invention the carrier has preferably been oriented in machine direction.

The longitudinal strength (tensile strength and stress at 10% extension) is advantageously increased as a result of the machine-direction drawing and as a result of the CNTs as reinforcing fibres.

The carrier of the adhesive tape of the invention has in one preferred embodiment a machine-direction tensile strength of at least 300, preferably at least 400 and in particular at least 500 N/mm².

The machine-direction stress at 10% extension is in one preferred embodiment at least 170, preferably at least 200 and in particular at least 300 N/mm².

The thickness of the carrier is preferably between 25 and 200, with particular preference between 40 and 140 and in particular between 50 and 90 μm.

Besides the use of polypropylene and of the CNTs, the orientation of the carrier in machine direction is a characteristic of the subject matter of the invention that leads to a substantial improvement in the properties.

The orientation of the film or films of the carrier is carried out at a temperature which lies below the crystallite melting temperature of the polypropylene.

Both with and without CNTs, stretching the extrudate in the melted state leads to only a slight improvement in tensile strength and stress at 10% extension in the resulting film. This operation is typically performed in order to adjust the ultimate thickness, between calender or extruder die and cooling section, and is not referred to as orientation.

The orientation (also called drawing) can be carried out on commercially customary apparatus known to the skilled person, of the kind used, for example, in the first operational step of the drawing of biaxially oriented films. It is advantageous for the properties of the carrier to conduct the operation in such a way that there is essentially only a slight decrease in the width of the film or films. At the same time the length of the film or films increases by a factor which is referred to as the draw ratio. In accordance with the invention the draw ratio is preferably 1:5 to 1:10, with particular preference 1:6.5 to 1:7.5.

Suitable raw materials for the carrier film or films of the invention are homopolymers, copolymers or terpolymers of propylene. The tacticity may for example be atactic, isotactic or syndiotactic, preference being given to predominantly isotactic polymers. The melt index of the polypropylene is preferably between 0.3 and 15 g/10 min and with particular preference between 2 and 10 g/10 min. Mixtures of polypropylenes can also be used. Polypropylenes with a block structure are preferred, for example an isotactic hard block of PP and an amorphous soft block of PE rubber.

The flexural modulus of the polypropylene polymer is preferably between 1000 and 1450 MPa.

The carrier films may comprise further polymers or additives known to the skilled worker, since the use of additives such as antioxidants, UV absorbers, antiblocking agents, lubricants, light stabilizers, fillers, pigments or compatibilizers is advantageous. Compatibilizers may have the effect, for example, of facilitating the dispersing of the CNTs or of increasing the tensile strength by improved attachment of the CNTs to the polymer matrix. Examples are polar-modified polyolefins such as, for example, maleic anhydride-grafted or acrylic acid-grafted polypropylenes and polyethylenes and also copolymers thereof such as EVA, for example. In particular it is also possible to use additives which influence the toughness. Examples of such are plasticizers (such as mineral oils or plasticizer resins), unsaturated or (partially) hydrogenated resins (based for example on natural resins or hydrocarbon resins), (optionally hydrogenated) styrene-diene block copolymers, plastomers (for example, copolymers of ethylene with long-chain polyolefins such as butene, hexene or octene), EPDM or LLDPE (in particular of low density).

Light stabilizer additives are described in Gaechter and Müller, Taschenbuch der Kunststoff-Additive, Munich 1979, in Kirk-Othmer (3rd) 23, 615 to 627, in Encycl. Polym. Sci. Technol. 14, 125 to 148, and in Ullmann (4th) 8, 21; 15, 259, 676. Particularly suitable are HALS light stabilizers such as, for example, dimethyl succinate polymer with 4-hydroxy-2,2,6,6-tetramethyl-1-piperidineethanol (CAS No. 65447-77-0), bis(2,2,6,6-tetramethyl-4-piperidinyl) sebacate (CAS No. 52829-07-9) or poly[[6-[(1,1,3,3-tetramethylbutyl)amino]-1,3,5-triazine-2,4-diyl][[(2,2,6,6-tetramethyl-4-piperidyl)imino]-hexamethylene[(2,2,6,6-tetramethyl-4-piperidyl)imino]] (CAS No. 70624-18-9).

The amount of light stabilizer ought to be at least 0.15% by weight, preferably at least 0.30% by weight based on the carrier film or films.

Using antioxidants for the film or films (Irganox 1010 or trisnonylphenyl phosphate, for example) is advantageous though not mandatory. Other suitable UV absorbers, light stabilizers and ageing inhibitors are listed in EP 0 763 584 A1.

Antioxidants which can be used are, accordingly, N,N-di-2-naphthyl-p-phenylenediamine, 2,5-di(tert-amyl)hydroquinone, trimethyldihydroquinoline polymer and 6-ethoxy-2,2,4-trimethyl-1,2-dihydroquinoline, 2,6-di-tert-butyl-p-cresol, 2,2′-methylenebis(4-methyl-6-tert-butylphenol), 4,4′-butylidenebis(3-methyl-6-tert-butylphenol), 4,4′-thiobis(3-methyl-6-tert-butylphenol), stearyl beta-(3,5-di-tert-butyl-4-hydroxyphenyl)propionate, tetrakis[methylene-3-(3′,5′-di-tert-butyl-4′-hydroxyphenyl)propionate]methane, 1,3,5-trimethyl-2,4,6-tris(3,5-di-tert-butyl-4-hydroxybenzyl)benzene and 1,1,3-tris(2-methyl-4-hydroxy-5-tert-butylphenol)butane, dilauryl thiodipropionate, distearyl thiodipropionate, lauryl stearyl thiodipropionate and dimyristyl thiodipropionate, triisodecyl phosphite, diphenyl isodecyl phosphite, triphenyl phosphite and trinonyl phosphate, and also N-salicyloyl-N′-aldehydehydrazine, N-salicyloyl-N′-acetylhydrazine, N,N′-diphenyloxamide and N,N′-di(2-hydroxyphenyl)oxamide.

Suitable CNTs are SWNTs and MWNTs, especially MWNTs, since they can be distributed more easily and more effectively in the polymer matrix. Even better are MWNTs having an aspect ratio of less than 1000, since they are likewise readily dispersible and are unobjectionable in respect of risks of health damage. All of the CNTs known or described in the prior art can be used in accordance with the invention.

In certain embodiments the carbon nanotubes may have been chemically functionalized or otherwise modified. Chemical modification may simplify the mixing and/or dispersing of the polymer matrix. In certain embodiments the chemically modified CNTs may interact sterically and/or with the polymer matrix, and in other embodiments, in turn, the chemical interaction encompasses covalent bonding of the CNTs or CNT derivatives to the polymer matrix, which may lead to crosslinking. Moreover, the CNTs may have been processed in masterbatches in order to ensure better dispersion and processing.

The composites may have a CNT concentration of 0.1% to 30% by weight, preferably 0.5% to 5% by weight, meaning that the CNTs are in dispersion in the film or films at a concentration of 0.1% to 30% by weight.

The films may have been given surface treatments. Examples of such treatments are, for the purpose of promoting adhesion, corona treatment, flame treatment or plasma treatment, or coatings of solutions or dispersions or liquid, radiation-curable materials. Further possible coatings are imprints and anti-stick coatings, examples being those of crosslinked silicones, acrylates (for example Primal™ 205), polymers with vinylidene chloride or vinyl chloride as monomer, or stearyl compounds such as polyvinyl stearyl-carbamate or chromium stearate complexes (for example Quilon™ C) or reaction products of maleic anhydride copolymers and stearylamine. The films may have been modified by lamination or radiation treatment.

For the adhesive-tape application the carrier is coated on one or both sides preferably with pressure-sensitive adhesive in the form of a solution or dispersion or in 100% form (melt, for example) or, preferably, by coextrusion with the film or films. With further preference coating takes place over the whole area on the carrier side.

The adhesive layer or layers may be crosslinked by heat or high-energy radiation and if required may be lined with release film or release paper. Suitable pressure-sensitive adhesives are described in D. Satas, Handbook of Pressure Sensitive Adhesive Technology (Van Nostrand Reinhold). Particularly suitable are pressure-sensitive adhesives based on acrylate, natural rubber, thermoplastic styrene block copolymer or silicone.

In order to optimize the properties, the adhesive employed, preferably a self-adhesive, can be blended with one or more additives such as tackifiers (resins), plasticizers, fillers, pigments, UV absorbers, light stabilizers, ageing inhibitors, crosslinking agents, crosslinking promoters or elastomers.

Suitable elastomers for blending are, for example, EPDM rubber or EPM rubber, polyisobutylene, butyl rubber, ethylene-vinyl acetate, hydrogenated block copolymers of dienes (for example, by hydrogenation of SBR, cSBR, BAN, NBR, SBS, SIS or IR; polymers of this kind are known for example as SEPS and SEBS) or acrylate copolymers such as ACM.

Tackifiers are, for example, hydrocarbon resins (of unsaturated C₅ or C₇ monomers, for example), terpene-phenol resins, terpene resins from raw materials such as α- or β-pinene, aromatic resins such as coumarone-indene resins, or resins of styrene or α-methylstyrene such as rosin and its derivatives such as disproportionated, dimerized or esterified resins, in which case it is possible to use glycols, glycerol or pentaerythritol, and also others as listed in Ullmann's Enzyklopädie der technischen Chemie, Volume 12, pp. 525 to 555 (4th ed.), Weinheim. Particularly suitable are ageing-stable resins without an olefinic double bond, such as hydrogenated resins, for example.

Examples of suitable fillers and pigments are carbon black, titanium dioxide, calcium carbonate, zinc carbonate, zinc oxide, silicates or silica.

Suitable UV absorbers, light stabilizers and ageing inhibitors for the adhesives are the same as those that can also be added to the film or films.

Examples of suitable plasticizers are aliphatic, cycloaliphatic and aromatic mineral oils, diesters or polyesters of phthalic acid, trimellitic acid or adipic acid, liquid rubbers (nitrile rubbers or polyisoprene rubbers, for example), liquid polymers of butene and/or isobutene, acrylic esters, polyvinyl ethers, liquid resins and plasticizer resins based on the raw materials for tackifier resins, wool wax and other waxes, or liquid silicones. Of particular suitability are ageing-stable plasticizers without an olefinic double bond.

Examples of crosslinking agents are phenolic resins or halogenated phenolic resins, melamine resins and formaldehyde resins. Examples of suitable crosslinking promoters are maleimides, allyl esters such as triallyl cyanurate, and polyfunctional esters of acrylic and methacrylic acid.

The thickness of coating with adhesive is preferably in the range from 18 to 50, in particular 22 to 29 g/m². The width of the adhesive-tape rolls is preferably in the range from 2 to 60 mm.

The preferred process for producing the adhesive tape of the invention is characterized by the following operational steps:
mixing of the polypropylene with CNTs for example in an extruder or compounder to give a compound, with subsequent granulation
melting of the compound of polypropylene and CNTs in an extruder
cooling of the melt to form a film
drawing of the film in machine direction (optionally in-line on the same unit)
coating with pressure-sensitive adhesive
converting to form rolls.

Instead of a compound it is also possible to use mixtures of polypropylene and a CNT masterbatch. The compounding of CNTs and polypropylene can be carried out in a film extruder provided that the latter possesses suitable mixing elements.

Extrusion can be carried out by a blown-film or casting process. Alternatively the components can be mixed in a compounder or extruder, and the mixture supplied to a calender for the forming of the film. Drawing then takes place in-line or off-line.

Instead of a coating with pressure-sensitive adhesive, this adhesive can be applied by coextrusion in the course of film production.

The adhesive tape of the invention is suitable for numerous applications, particularly for packaging applications, for example for bundling or binding, as transit securement (pallets or doors of household appliances) or for the tear-opening of packaging. The disadvantages of filament adhesive tapes, such as low crease fracture resistance, unclean cut edges and involved production, are not exhibited by the adhesive tape of the invention.

The key technical characteristic of the invention is the combination of high lateral-tear resistance (tear propagation strength and residual strength) and high longitudinal strength (tensile strength and stress at 10% extension) in machine direction.

Test Methods

Thickness: DIN 53370

Tensile strength: DIN 53455-7-5

Stress at 10% extension: DIN 53455-7-5

Breaking extension: DIN 53455-7-5

Melt index: DIN 53735 (PP 230° C., 2.16 N; PE 190° C., 2.16 N)

Flexural modulus: ASTM D 790 A

Adhesive data: AFERA 4001, corresponding to DIN EN 1939

The examples which follow are intended to illustrate the invention without restricting it.

### EXAMPLES

### Example 1

97.0 parts by weight of Dow 7CO6 (PP block copolymer, MFI 1.5 g/10 min, flexural modulus 1280 MPa, Dow) were mixed with 1.7 parts by weight of Fusabond MB 528 D (MFI 6.8 g/10 min, acid-grafted LLDPE, DuPont) and 1.3 parts by weight of Baytubes™ C 150 P (Multiwall CNTs with 3 to 5 layers, average diameter 13 to 16 nm, length 1 to 10 μm, Bayer Material Science) in a twin-screw extruder, the mixture was extruded, the extrudate was pelletized and the pellets were dried. The compound obtained was melted in an extrusion unit, formed in a width of 60 cm on a chill roll and oriented in machine direction (md) at 118° C. with a ratio of 1:6.5.

Test Results:

| Thickness after drawing | 55 μm |
|---|---|
| Tensile strength md | 453 N/mm² |
| Stress at 10% extension md | 250 N/mm² |
| Breaking extension | 19% |

The film was corona-pretreated on both sides, coated on the top face with a 0.5% strength solution of PVSC in toluene, as release, and dried. The adhesive was mixed in the melt from 42% by weight of SIS elastomer, 20% by weight of a pentaerythritol ester of hydrogenated rosin, 37% by weight of a C₅ hydrocarbon resin having an R&B value of 85° C. and 1% by weight of Irganox™ 1010 antioxidant, and was applied to the bottom face of the film at 150° C. using a nozzle. The adhesive tape was subsequently wound up to form a stock roll and for further testing was slit (razor slitter) to a width of 15 mm.

Adhesive Data:

| | |
|---|---|
| Bond strength on steel | 1.6 N/cm |
| Unwind force at 0.3 m/min | 0.8 N/cm |
| Unwind force at 30 m/min | 0.5 N/cm |
| Coatweight | 21 g/m² |

### Example 2

82.0 parts by weight of Moplen™ HP 456 H (PP homopolymer, MFI 1.8 g/10 min, flexural modulus 1450 MPa, Basell), 15 parts by weight of Elie™ 5400 (ethylene copolymer, MFI 1 g/10 min, density 0.916 g/cm³, Dow) and 1.7 parts by weight of Scona TPPP 2112 FA (MFI 5 g/10 min, maleic anhydride-grafted PP homopolymer, Kometra) were mixed, subjected to cryogrinding and then mixed with 1.3 parts by weight of ATI-MWNT-001 (multiwall CNTs unbundled as grown 95% form, 3 to 5 layers, average diameter 20 to 50 nm, length 0.5 to 200 μm, Ahwahnee) in a dry blender. The mixture was melted in a Banbury compounder and supplied via a rollmill and a conveyor belt to a calender (inverted L type). The primary film was formed with thickness of 300 μm and at 128° C. was oriented in machine direction in a ratio of 1:5.8 using a drawing frame.

Test Results:

| Thickness after drawing | 53 μm |
|---|---|
| Tensile strength md | 690 N/mm² |
| Stress at 10% extension md | 375 N/mm² |
| Breaking extension | 21% |

The film was corona-pretreated on both sides, coated on the top face with a solvent-free silicone which was subsequently crosslinked with UV radiation. The bottom face was provided with a primer of natural rubber, cyclorubber and 4,4′-diisocyanatodiphenyl-methane. The adhesive was dissolved in hexane in a kneader from 40% by weight of natural rubber SMRL (Mooney 70), 10% by weight of titanium dioxide, 37% by weight of a C₅ hydrocarbon resin having an R&B value of 95° C. and 1% by weight of Vulkanox™ BKF antioxidant. The adhesive, at 20% by weight, was applied with a coating bar to the primed bottom face of the film, and dried at 115° C. Subsequently the adhesive tape was wound up to a stock roll and for further testing was slit to a width of 15 mm (razor slitter).

Adhesive Data:

| | |
|---|---|
| Bond strength on steel | 2.1 N/cm |
| Unwind force at 0.3 m/min | 0.2 N/cm |
| Unwind force at 30 m/min | 0.1 N/cm |
| Coatweight | 23 g/m² |

### Comparative Example 1

### Single-Layer Film

A strapping-grade film was produced from Moplen EPQ 30 RF with a draw ratio of 1:8. Processing to adhesive tape was carried out in the same way as in Example 1 of EP 1 101 808 A1.

Test Results:

| Thickness afterdrawing | 85 μm |
|---|---|
| Tensile strength md | 290 N/mm² |
| Stress at 10% extension md | 169 N/mm² |
| Breaking extension | 35% |

### Comparative Example 2

### Single-Layer Film

A film and an adhesive tape were produced in the same way as in Comparative Example 1 from Dow 7CO6 (PP block copolymer, MFI 1.5 g/10 min, flexural modulus 1280 MPa) with a draw ratio of 1:6.6.

Test Results:

| Thickness after drawing | 85 μm |
|---|---|
| Tensile strength md | 306 N/mm² |
| Stress at 10% extension md | 166 N/mm² |
| Breaking extension | 25% |

### Comparative Example 3

### Two-Layer Film

In DE 36 40 861 A1 Example 1 has the highest tensile strength and machine-direction stress at 10% extension. The draw ratio was 1:7.5.

Test Results:

| Thickness after drawing | 85 μm |
|---|---|
| Tensile strength md | 215 N/mm² |
| Stress at 10% extension md | 104 N/mm² |
| Breaking extension | 40% |

### Comparative Example 4

### One-Layer Film

Test results of Example 1 of EP 0 255 866 A1 (draw ratio 1:7):

| | |
|---|---|
| Thickness after drawing | 40 μm |
| Tensile strength md | 235 N/mm² |
| Other technical data | not measured |

### Comparative Example 5

### Film with Coextruded Filament

In EP 1 101 808 A1 Example 1 has the highest tensile strength and machine-direction stress at 10% extension. The draw ratio was 1:8.7.

Test Results:

| Thickness after drawing | 77 μm |
|---|---|
| Tensile strength md | 231 N/mm² |
| Stress at 10% extension md | 147 N/mm² |
| Breaking extension | 34% |

### Comparative Example 6

### Film with Rib Structure

In U.S. Pat. No. 5,145,544 A1 Example V has the highest machine-direction tensile strength. The draw ratio is unknown.

Test Results:

| | |
|---|---|
| Thickness after drawing | 114 μm |
| Tensile strength md | 335 N/mm² |

1. Adhesive tape having a carrier which is composed of one or more carrier films, at least one side of the carrier bearing an adhesive applied at least partially, characterized in that at least one of the carrier films comprises at least one homopolymer, copolymer or terpolymer of propylene and in that there are carbon nanotubes (CNTs) in at least one of the carrier films.

2. Adhesive tape according to claim 1, wherein the carrier has been oriented in the machine direction or is composed of a single carrier film, or is both composed of a single carrier film and oriented in the machine direction.

3. Adhesive tape according to claim 1, wherein
the carrier has a machine-direction tensile strength of at least 300 N/mm², or
the carrier has a machine-direction stress at 10% extension of at least 170 N/mm² or
the carrier has a thickness of between 25 and 200 μm, or any combination of said properties.

4. Adhesive tape according to claim 1, wherein the carrier film or films have been oriented in machine direction with a draw ratio of 1:5 to 1:10.

5. The adhesive tape according to claim 1, wherein the carrier comprises a polypropylene raw material having a melt index of 0.3 to 15 g/10 min or having a flexural modulus of between 1000 and 1450 MPa or having both said melt index and said flexural modulus.

6. Adhesive tape according to claim 1, wherein the CNTs are multiwalled carbon nanotubes (MWNT).

7. The adhesive tape according to claim 1, wherein the CNTs have an aspect ratio of less than 10 000.

8. Adhesive tape according to claim 1, wherein the CNTs are in dispersion in the film or films at a concentration of 0.1% to 30% by weight.

9. Adhesive tape according to claim 1, wherein the CNTs are chemically functionalized or modified.

10. Adhesive tape according to claim 1, wherein the adhesive is applied at a coating thickness in the range of from 18 to 50 g/m².

11. Process for producing an adhesive tape of claim 1, comprising the steps of:
mixing of the polypropylene with CNTs, optionally with subsequent granulation
optionally, melting of a compound of polypropylene and CNTs in an extruder
cooling of the melt to form a film in an extrusion or calendering process
drawing of the film in machine direction
coating with adhesive
converting to form rolls.

12. Process for producing an adhesive tape according to claim 11, wherein compatibilizers are added to ensure better dispersing and processing of the CNTs.

13. The adhesive tape of claim 3, wherein said tensile strength is at least 500 N/mm², said stress is at least 300 N/mm² and said thickness is between 50 and 90 μm.

14. The adhesive tape of claim 5, wherein said melt index is 2 to 10 g/10 min.

15. The adhesive tape of claim 7, wherein said aspect ratio is less than 1000.

16. The adhesive tape of claim 8, wherein said concentration is 0.5 to 5% by weight.

17. The adhesive tape of claim 10, wherein said coating thickness is 22 to 29 g/m².
